(19) United States
(12) Patent Application Publication
(10) Pub. No.: US 2017/0191288 A1
(43) Pub. Date: Jul. 6, 2017

(54) DOOR LATCH ASSEMBLY

(71) Applicant: Thase Enterprise Co., Ltd., Taipei (TW)

(72) Inventor: Ching Tien LIN, Taipei (TW)

(21) Appl. No.: 14/987,891

(22) Filed: Jan. 5, 2016

(51) Int. Cl. E05B 65/10; E05C 3/24

(52) U.S. Cl. CPC E05B 65/1006; E05C 3/24; E05B 65/1046

(57) ABSTRACT

A door latch assembly includes two receptacles mounted to a door panel and spaced from each other, two latchbolts pivotally attached to the receptacles for engaging with strikes and for locking the door panel to a door frame, two sliding members slidably engaged in the receptacles and each having a protrusion for engaging with the latchbolts, two spring biasing members engaged between the sliding members and the receptacles for biasing the sliding members toward the strikes, and two actuating levers connected between the sliding members and a push bar for allowing the sliding members to be moved away from the latchbolts by the push bar with the actuating levers selectively.

### BACKGROUND OF THE INVENTION

1. Field of the Invention

The present invention relates to a door latch assembly for a panic exit door, and more particularly to a door latch assembly for a panic exit door including an improved and simplified structure or configuration for allowing the door latch assembly to be easily and quickly made or manufactured with a reduced making or manufacturing procedure and/or cost and to be easily and quickly assembled by the workers or the like.

2. Description of the Prior Art

Various kinds of typical door latch assemblies for panic exit doors have been developed and provided for latching or locking the exit doors and comprise a push bar connected or coupled to a door latch assembly for actuating or operating the door latch assembly to lock and release the exit doors.

For example, U.S. Pat. No. 5,464,259 to Cohrs et al., U.S. Pat. No. 6,009,732 to Haeck et al., and U.S. Patent Application Publication No. 2012/0032455 A1 to Lin disclose several of the typical door latch assemblies for panic exit doors and each also comprising a door latch assembly including an upper latch device and a lower latch device for selectively latching or locking an exit door panel to a door frame, and a push bar connected or coupled to the upper latch device and the lower latch device of the door latch assembly for actuating or operating the door latch assembly to lock and release the exit doors.

However, the upper and the lower latch devices of the door latch assembly should be actuated or operated by a complicated connecting or coupling mechanism, in addition, the upper and the lower latch devices of the door latch assembly also include a complicated connecting or coupling mechanism, such that the making or manufacturing procedures and/or the cost may be greatly increased.

The present invention has arisen to mitigate and/or obviate the afore-described disadvantages of the conventional door latch assemblies.

### SUMMARY OF THE INVENTION

The primary objective of the present invention is to provide a door latch assembly including an improved and simplified structure or configuration for allowing the door latch assembly to be easily and quickly assembled by the workers and for allowing the door latch assembly to be easily and quickly made or manufactured with a reduced making or manufacturing procedure and/or cost and to be easily and quickly assembled by the workers or the like.

In accordance with one aspect of the invention, there is provided a door latch assembly comprising a door frame, a door panel engaged in the door frame, a push bar attached to the door panel, two strikes each including a chamber formed therein, and each strike including a tongue extended into the chamber of the strike, two receptacles mounted to the door panel and spaced from each other, the receptacles each including a compartment formed therein and defined by a base wall and two side walls, the receptacles each including an ear extended into the compartment of the receptacle, and the ears each including an opening formed therein and communicating with the compartment of the receptacle, two latchbolts pivotally attached to the receptacles respectively for selectively engaging with the strikes respectively and for selectively locking the door panel to the door frame, the latchbolts each including a notch formed therein and defined between two flaps for selectively engaging with the tongue of the strike and for selectively locking the door panel to the door frame, and the latchbolts each including a projection extended therefrom, two sliding members slidably received and engaged in the chambers of the receptacles respectively, the sliding members each including a protrusion extended therefrom for selectively engaging with the projections of the latchbolts respectively and for positioning the latchbolts to the receptacles at the selected opened or close position, the sliding members each including an extension extended therefrom and slidably engaged into the openings of the ears of the receptacle respectively for guiding and limiting the sliding members to move relative to the receptacle, two spring biasing members engaged between the sliding members and the receptacles respectively for biasing and forcing the sliding members toward the strikes respectively, and two actuating levers connected between the sliding members and the push bar for allowing the sliding members to be moved away from the latchbolts by the push bar with the actuating levers selectively. The door latch assembly includes an improved and simplified structure or configuration for allowing the door latch assembly to be easily and quickly made or manufactured with a reduced making or manufacturing procedure and/or cost and to be easily and quickly assembled by the workers or the like.

The latchbolts are pivotally attached to the receptacles with pivot shafts respectively, and two spring biasing elements are engaged between the latchbolts and the receptacles respectively for biasing and forcing the latchbolts to engage with the tongue of the strikes respectively and for allowing the latchbolts to be engaged with the strikes automatically.

The latchbolts each include a curved cam member provided thereon, and two guide posts are secured to the side walls of the receptacle and extended through the compartment of the receptacle for selectively and smoothly contacting or engaging with the cam member of the latchbolt and for stably and solidly guiding the latchbolt to rotate relative to the receptacle and for preventing the latchbolt from being tilted or shifted or disengaged from the receptacle.

The protrusions of the sliding members each include a tapered or rounded free end portion provided thereon for smoothly engaging with the projection of the latchbolt and for anchoring and positioning the latchbolt to the receptacle at the selected opened or close position selectively and for allowing the door panel to be selectively locked or latched to the door frame automatically.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a latch mechanism of a door latch assembly for a panic exit door in accordance with the present invention;

FIG. 2 is a partial cross sectional view of the door latch assembly;

FIGS. 3, 4, 5, 6 are partial cross sectional views similar to FIG. 2, illustrating the operation of the latch mechanism for the door latch assembly;

FIG. 7 is a partial perspective view of the latch mechanism for the door latch assembly;

FIG. 8 is an enlarged partial perspective view of the latch mechanism for the door latch assembly;

FIG. 9 is a partial exploded view of the latch mechanism for the door latch assembly; and

FIG. 10 is another enlarged partial perspective view of the latch mechanism for the door latch assembly.

### DETAILED DESCRIPTION OF THE PREFERRED EMBODIMENT

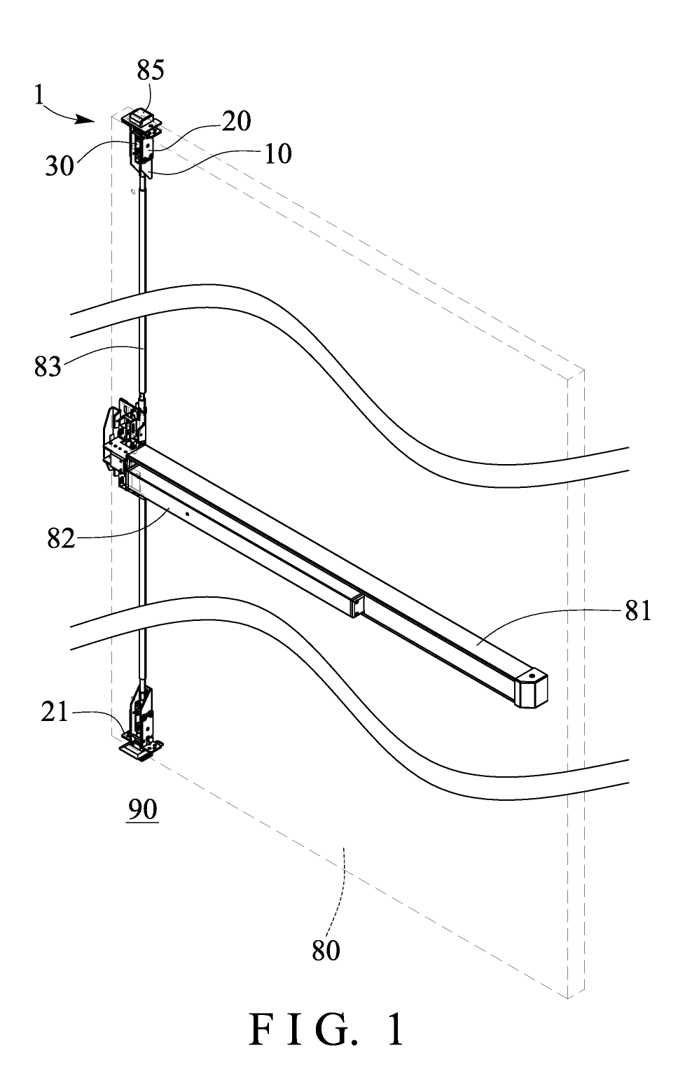

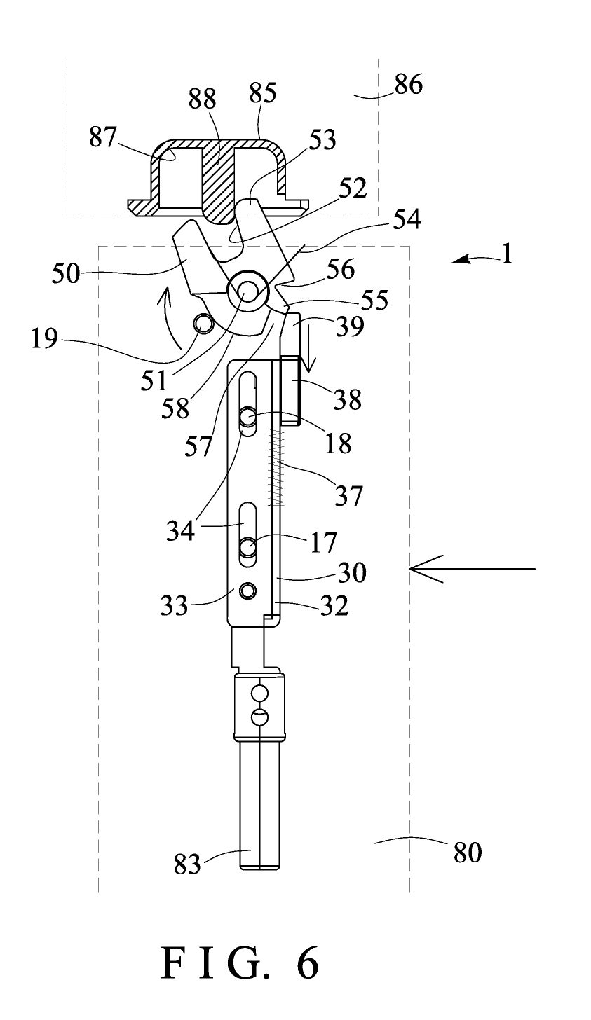

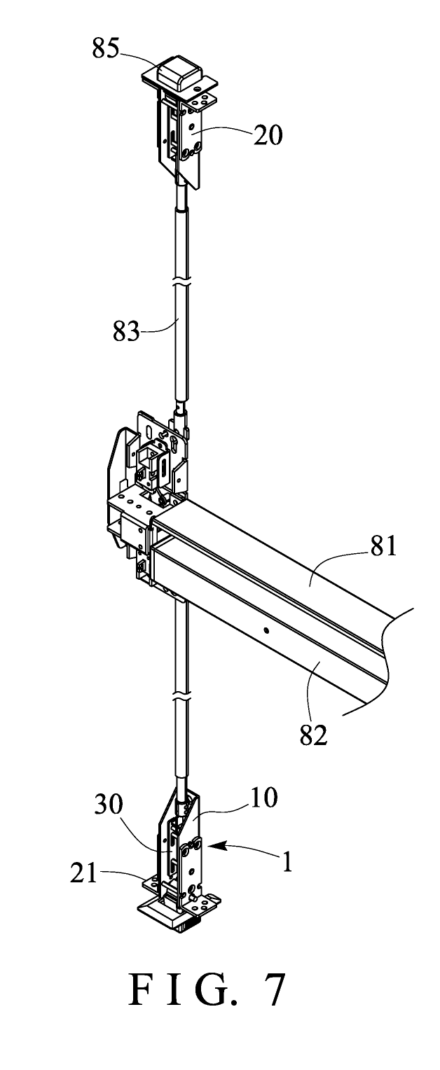

Referring to the drawings, and initially to FIGS. 1-6, a door latch assembly in accordance with the present invention comprises a latch mechanism including one or more (such as two) transmitting or latch devices 1 disposed or engaged into a door panel 80, such as an exit door panel 80 that is disposed or engaged into a door frame 86, and preferably arranged or located at one side or edge portion of the door panel 80 (FIG. 1), and mounted or secured to the door panel 80 with screws or catches or fasteners (not illustrated) or the like, and as shown in FIGS. 1 and 7, the door panel 80 includes a box or casing 81 attached or mounted to the inner or indoor portion of the door panel 80, and a push bar 82 slidably attached or mounted to the casing 81 and connected or coupled to the latch devices 1 with one or more (such as two) actuating levers 83 for selectively actuating or operating the actuating levers 83 to actuate or operate the latch devices 1 of the latch mechanism.

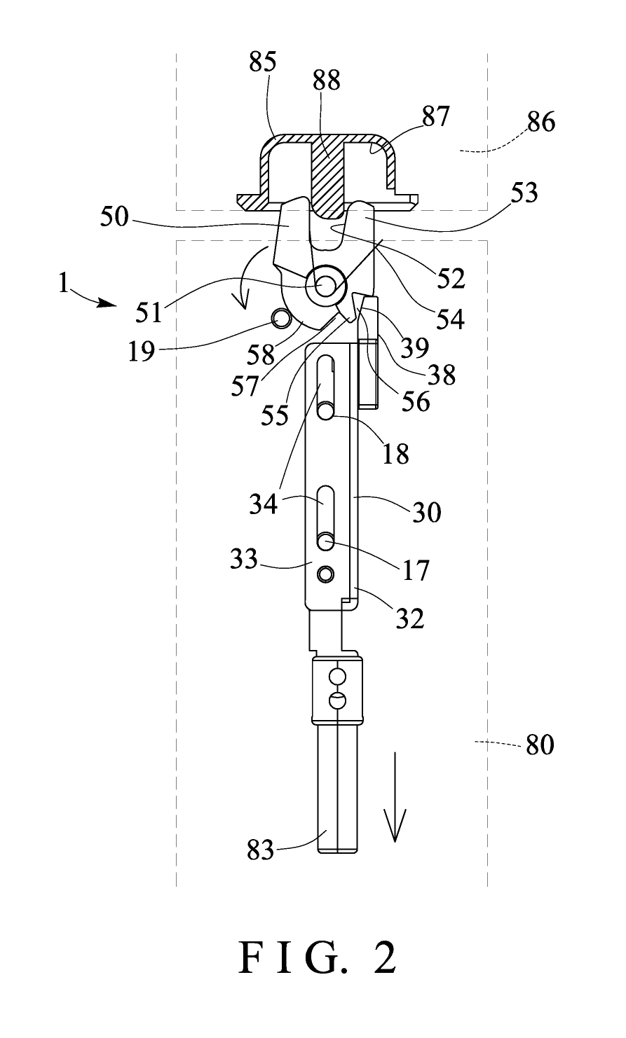

One or more (such as two) strikes 85 are disposed or engaged into the door frame 86 and/or a floor 90 (FIG. 1), and the strikes 85 each include a compartment or chamber 87 formed therein, and each include a tongue 88 (FIGS. 2-6, 9) extended into the chamber 87 of the respective strike 85 for selectively contacting or engaging with the latch device 1 of the latch mechanism. The above-described structure or configuration for the push bar 82 and the actuating levers 83 is typical and is not related to the present invention and will not be described in further details. The latch devices 1 of the latch mechanism each include a housing or receptacle 10 attached or mounted to the inner or indoor portion of the door panel 80 and disposed and arranged or located close to the strikes 85 respectively with screws or catches or fasteners (not illustrated) or the like, and/or secured to the door panel 80 with one or more (such as two) elbows or brackets 20, 21 respectively.

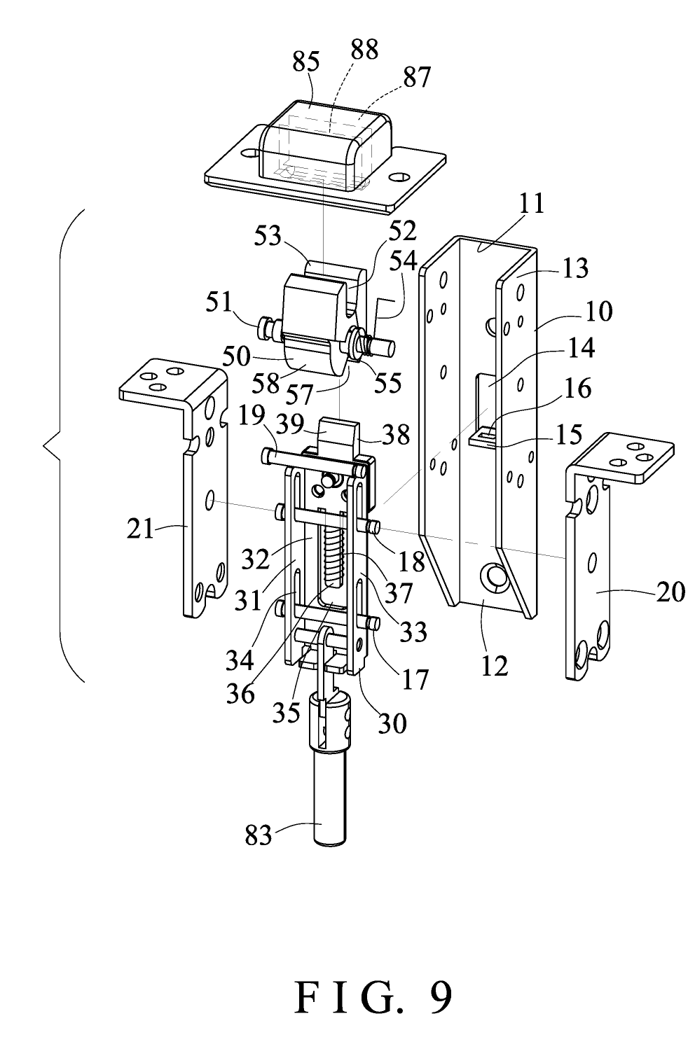

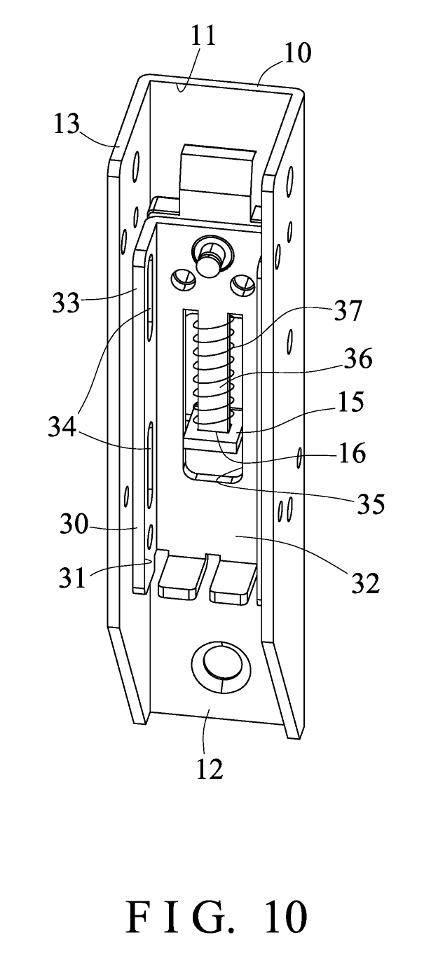

As shown in FIG. 9, the receptacle 10 includes a chamber or compartment 11 formed therein and formed or defined by a base wall 12 and two side walls 13, and includes an orifice 14 formed in the base wall 12 of the receptacle 10, and includes a flap or ear 15 extended laterally from the base wall 12 and into the compartment 11 of the receptacle 10, and includes an opening 16 formed in the ear 15 and communicating with the compartment 11 of the receptacle 10, and includes one or more (such as two) guide shafts or rods 17, 18 and a guide shank or post 19 secured to and extended or straddled between the side walls 13 of the receptacle 10, and extended laterally through the compartment 11 of the receptacle 10, and further includes a follower or sliding member 30 slidably received or engaged in the compartment 11 of the respective receptacle 10.

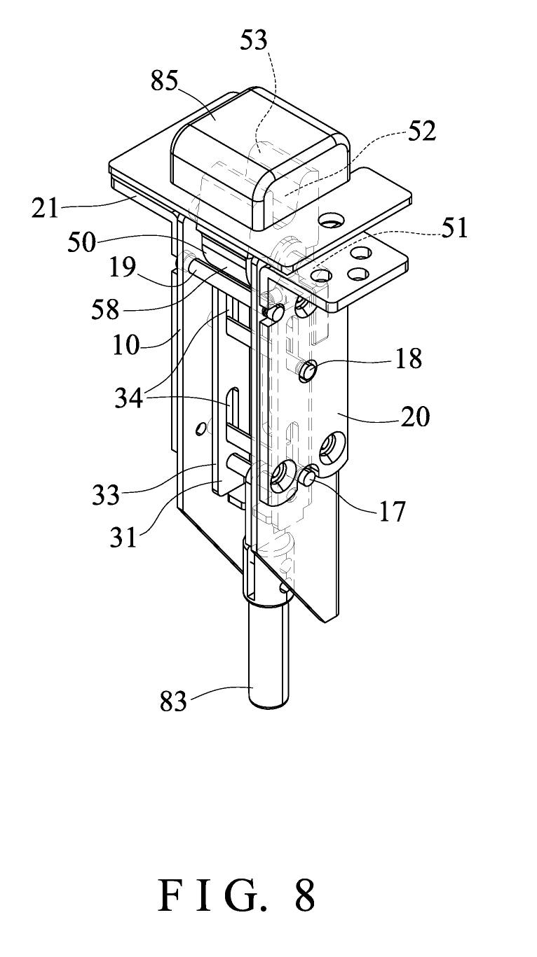

The sliding members 30 each include a compartment or space 31 formed therein and formed or defined by a base plate 32 and two side plates 33, and each include one or more (such as two) guide slots 34 formed therein, such as formed in the side plates 33 for slidably receiving or engaging with the guide rods 17, 18 respectively and for guiding or limiting the sliding members 30 to slide or move up and down relative to the receptacle 10 (FIGS. 2-6 and 8). The sliding members 30 are connected or coupled to the actuating levers 83 for allowing the sliding members 30 to be actuated and moved relative to the receptacle 10 by the push bar 82 with the actuating levers 83 selectively. The sliding members 30 each include a guiding channel 35 formed therein, such as formed in the base plate 32 for slidably receiving or engaging with the ear 15 of the receptacle 10 and for further guiding or limiting the sliding members 30 to move relative to the receptacle 10.

The sliding members 30 each further include a guiding extension 36 extended therefrom, such as extended from the base plate 32 and extended into the guiding channel 35 for slidably engaging into or through the opening 16 of the ear 15 of the receptacle 10 and for further guiding or limiting the sliding members 30 to move relative to the receptacle 10. A spring biasing member 37 may further be provided and attached or engaged onto the guiding extension 36 and biased and engaged between the sliding member 30 and the ear 15 of the receptacle 10 for biasing and forcing or moving the sliding members 30 toward the strikes 85 respectively. The sliding members 30 each further include a protrusion 38 extended therefrom, such as extended toward the strikes 85 respectively, and the protrusions 38 each include an inclined or tilted or tapered or rounded free end portion 39 formed or provided thereon for smoothly contacting or engaging with the latchbolt and for anchoring and positioning the latchbolt to the receptacle at the selected opened or close position selectively which will be discussed hereinafter.

A rotary member or actuating element or latchbolt 50 is pivotally or rotatably attached or mounted to the receptacle 10 with a pivot shaft 51 which is extended or straddled between the side walls 13 of the receptacle 10, and includes a notch 52 formed therein and formed or defined between two limbs or flaps 53 for selectively receiving or engaging with the tongue 88 and/or the chamber 87 of the respective strike 85 (FIG. 2) and for selectively latching or locking the door panel 80 to the door frame 86. Another spring biasing member or element 54 is attached or engaged onto the pivot shaft 51 and/or engaged between the latchbolt 50 and the receptacle 10 for biasing and forcing or moving the latchbolt 50 to engage with the tongue 88 and/or the chamber 87 of the respective strike 85. The latchbolt 50 further includes a tongue or projection 55 extended therefrom and formed or defined between two recesses or seats 56, 57 for selectively engaging with the protrusion 38 of the sliding member 30.

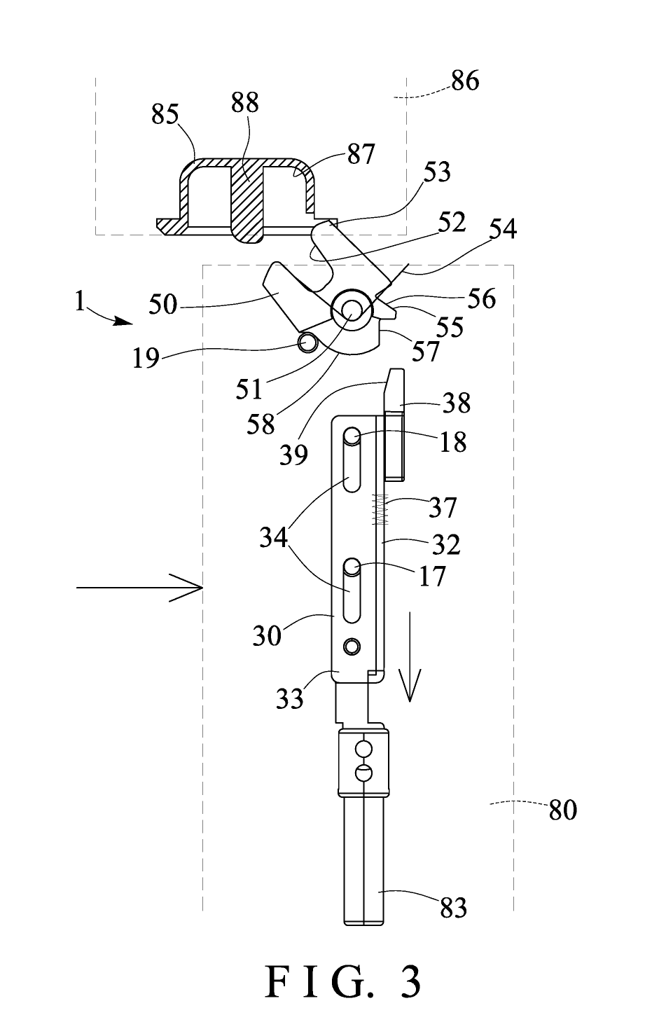

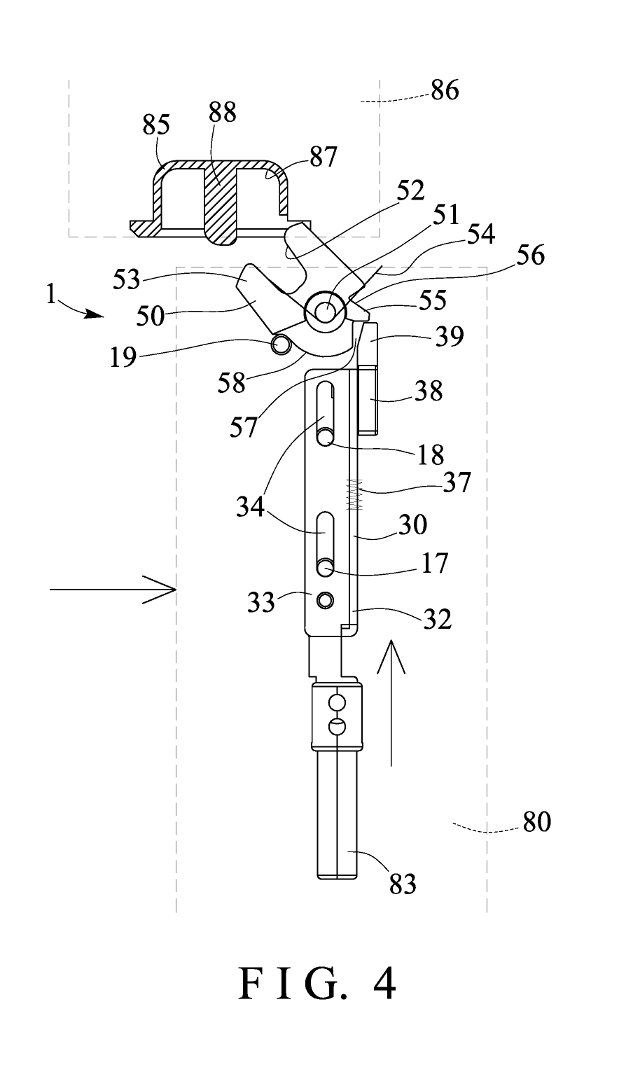

In operation, as shown in FIG. 2, the spring biasing element 54 may bias and force the latchbolt 50 to engage with the tongue 88 and/or the chamber 87 of the respective strike 85 and for selectively latch or lock the door panel 80 to the door frame 86. As shown in FIG. 3, when the sliding members 30 are actuated or moved away from the latchbolts 50 by the push bar 82 with the actuating levers 83, the protrusions 38 of the sliding members 30 may be actuated or moved away from the latchbolts 50 for allowing the latchbolt 50 to be pivoted or rotated relative to the receptacle 10, and thus for allowing the door panel 80 to be opened relative to the door frame 86. As shown in FIG. 4, when the push bar 82 is released, the spring biasing member 37 may bias and force the sliding member 30 to move toward the strike 85, and the protrusion 38 of the sliding member 30 may be actuated or forced to engage with the projection 55 and/or the seat 57 of the latchbolt 50 and retaining or maintaining the door panel 80 at the opened position relative to the door frame 86.

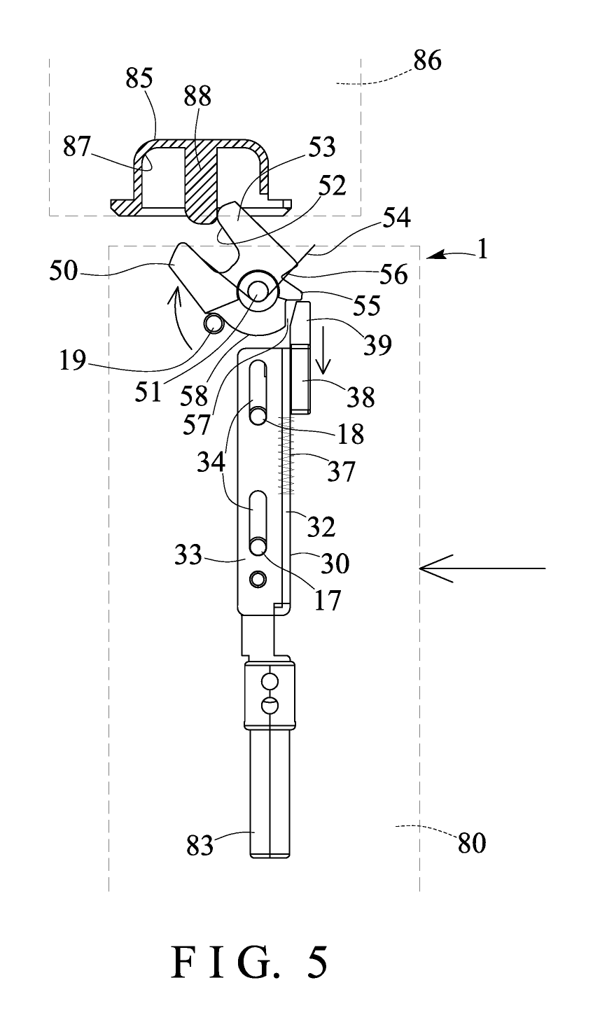

As shown in FIG. 5, when the door panel 80 is pushed into the door frame 86 toward the close position, the flaps 53 of the latchbolt 50 may be contacted or engaged with the tongue 88 of the strike 85, and the latchbolt 50 may be actuated or forced to pivot or rotate relative to the receptacle 10, and thus may actuate or force the protrusion 38 of the sliding member 30 to move toward the push bar 82 until the protrusion 38 of the sliding member 30 is moved beyond or over the projection 55 and/or the seat 57 of the latchbolt 50, and the protrusion 38 of the sliding member 30 may be contacted or engaged with the other seat 56 of the latchbolt 50 and to retain or maintain the door panel 80 at the close position relative to the door frame 86 as shown in FIG. 2. It is preferable that the latchbolt 50 includes a curved or convex guide or cam surface or cam member 58 formed or provided on the outer peripheral portion thereof for selectively contacting or engaging with the guide post 19 which may guide the latchbolt 50 to stably pivot or rotate relative to the receptacle 10 and which may prevent the latchbolt 50 from being tilted or shifted or disengaged from the receptacle.

Accordingly, the door latch assembly in accordance with the present invention includes an improved and simplified structure or configuration for allowing the door latch assembly to be easily and quickly made or manufactured with a reduced making or manufacturing procedure and/or cost and to be easily and quickly assembled by the workers or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door latch assembly comprising:
a door frame,
a door panel engaged in said door frame,
a push bar attached to said door panel,
two strikes each including a chamber formed therein, and each strike including a tongue extended into said chamber of said strike,
two receptacles mounted to said door panel and spaced from each other, said receptacles each including a compartment formed therein and defined by a base wall and two side walls, said receptacles each including an ear extended into said compartment of said receptacle, and said ears each including an opening formed therein and communicating with said compartment of said receptacle,
two latchbolts pivotally attached to said receptacles respectively for selectively engaging with said strikes respectively and for selectively locking said door panel to said door frame, said latchbolts each including a notch formed therein and defined between two flaps for selectively engaging with said tongue of said strike and for selectively locking said door panel to said door frame, and said latchbolts each including a projection extended therefrom,
two sliding members slidably received and engaged in said chambers of said receptacles respectively, said sliding members each including a protrusion extended therefrom for selectively engaging with said projections of said latchbolts respectively, said sliding members each including an extension extended therefrom and slidably engaged into said openings of said ears of said receptacle respectively for guiding and limiting said sliding members to move relative to said receptacle,
two spring biasing members engaged between said sliding members and said receptacles respectively for biasing and forcing said sliding members toward said strikes respectively, and
two actuating levers connected between said sliding members and said push bar for allowing said sliding members to be moved away from said latchbolts by said push bar with said actuating levers selectively.

2. The door latch assembly as claimed in claim 1, wherein said latchbolts are pivotally attached to said receptacles with pivot shafts respectively, and two spring biasing elements are engaged between said latchbolts and said receptacles respectively for biasing and forcing said latchbolts to engage with said tongue of said strikes respectively.

3. The door latch assembly as claimed in claim 1, wherein said latchbolts each include a curved cam member provided thereon, and two guide posts are secured to said side walls of said receptacle and extended through said compartment of said receptacle for selectively contacting with said cam member of said latchbolt and for guiding said latchbolt to rotate relative to said receptacle.

4. The door latch assembly as claimed in claim 1, wherein said protrusions of said sliding members each include a tapered free end portion provided thereon.
